(19) United States
(12) Patent Application Publication
(10) Pub. No.: US 2003/0233589 A1
(43) Pub. Date: Dec. 18, 2003

(54) Vehicle computer system including a power management system

(76) Inventor: Jose Alvarez, Hampton Bays, NY (US)

Correspondence Address: Sidley AUSTIN BROWN & WOOD LLP, 875 Third Avenue, New York, NY, 10022, US

(21) Appl. No.: 10/172,923

(22) Filed: Jun. 17, 2002

(51) Int. Cl. G06F 1/26

(52) U.S. Cl. 713/300

(57) ABSTRACT

A vehicle computer system comprising a power management system for ensuring that continuous power is supplied to the computer system even when the car is turned off. The computer system comprises a client computer, a server, a plurality of peripheral devices, a power cable for connecting the vehicle battery to the client computer and the peripherals, a backup battery connected to the vehicle battery by a switch such that the switch is turned on when the power from the vehicle battery is low, and a power inverter for converting an direct current voltage from the vehicle battery or the backup battery into an alternating current for powering the client computer and the peripherals.

### BACKGROUND OF THE INVENTION

The present invention relates to a vehicle computer system and more specifically a power management system for conserving the power supplied to the computer system.

Power management is critical in vehicle computer systems since vehicles have limited power derived from the vehicle's battery. Moreover, as vehicle computer systems use larger microprocessors and a greater number of peripheral devices, the power requirements increase. Most current vehicle computer systems include reduced instruction set computing (RISC) microprocessors since they are smaller and consume less power then complex instruction set computing (CISC) microprocessors such as the Intel Pentium (i.e, x86, IV) microprocessors.

### SUMMARY OF THE INVENTION

It is the object of the invention to provide a vehicle computer system that includes a power management system.

It is a further object of the invention to provide AC power to the vehicle computer system via a DC to AC inverter.

It is a still further object of the invention to provide continuous power to the vehicle computer system even when the vehicle battery is low on power or turned off by continuously feeding the vehicle battery with power from a backup battery via a switch.

It is yet another object of the invention to sense and detect objects and intruders surrounding the vehicle.

These and other objects of the invention can be achieved by a vehicle computer system comprising a power management system that supplies continuous power to the computer system even when the car is turned off. In accordance with the invention, the computer system comprises a client computer, a server, a plurality of peripheral devices, all connected by communication links, a power cable for connecting the vehicle battery to the client computer and the peripherals, a backup battery connected to the vehicle battery by a switch such that the switch is turned on when the power from the vehicle battery is low, and a power inverter for converting an direct current voltage from the vehicle battery or the backup battery into an alternating current for powering the client computer and the peripherals. The computer system further comprises a plurality of sensors and cameras attached to various locations around the periphery of a vehicle for detecting and recording objects near the car. The sensors transmit signals to an IrDa port within the client computer for client computer to turn the cameras on and the cameras transmit images of the objects to the client computer.

### BRIEF DESCRIPTION OF THE INVENTION

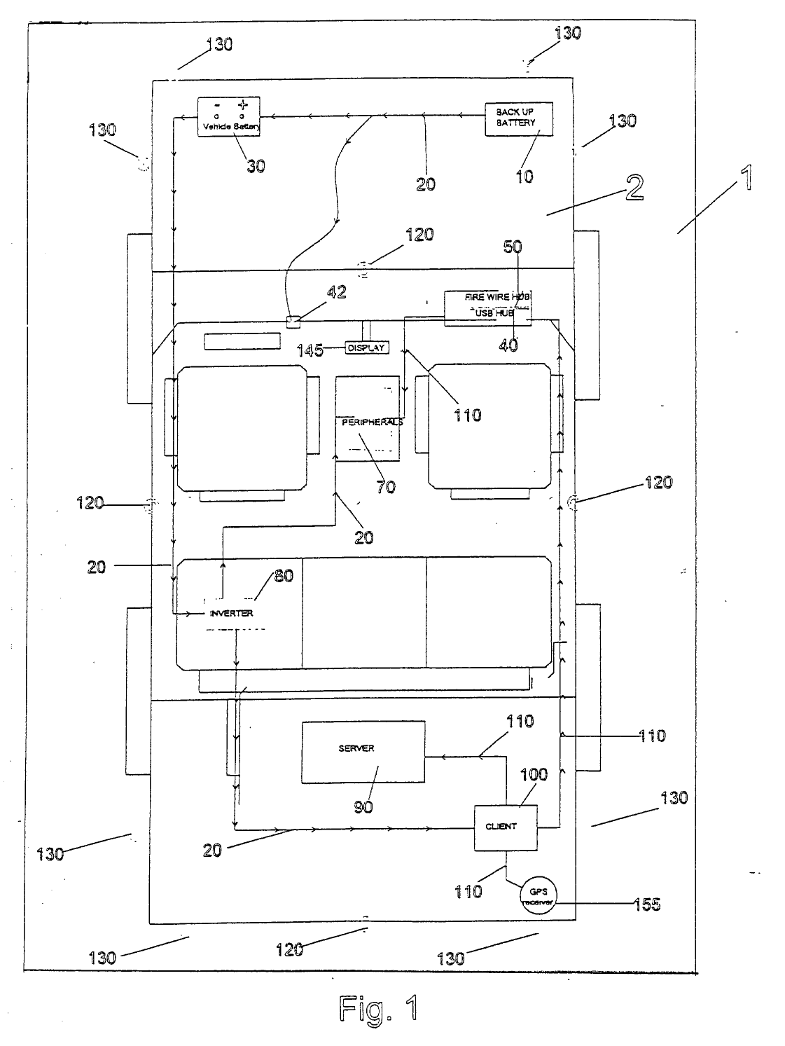

FIG. 1 is a schematic depiction of a vehicle including the vehicle computer system in accordance with the present invention;

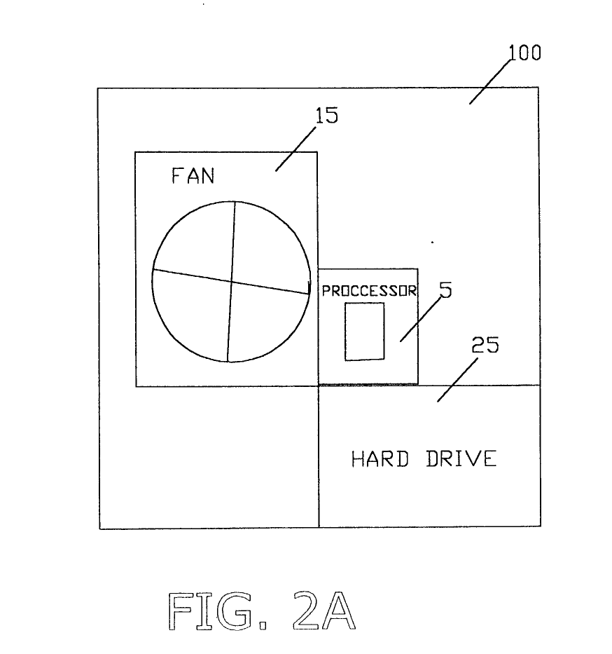

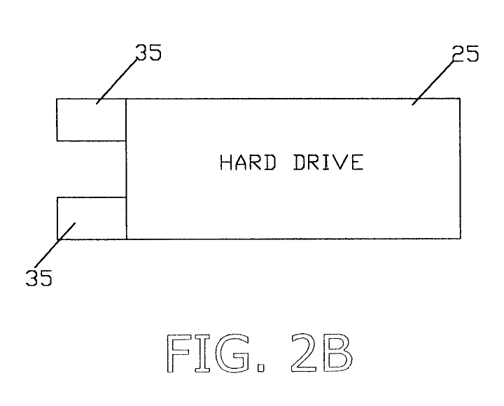

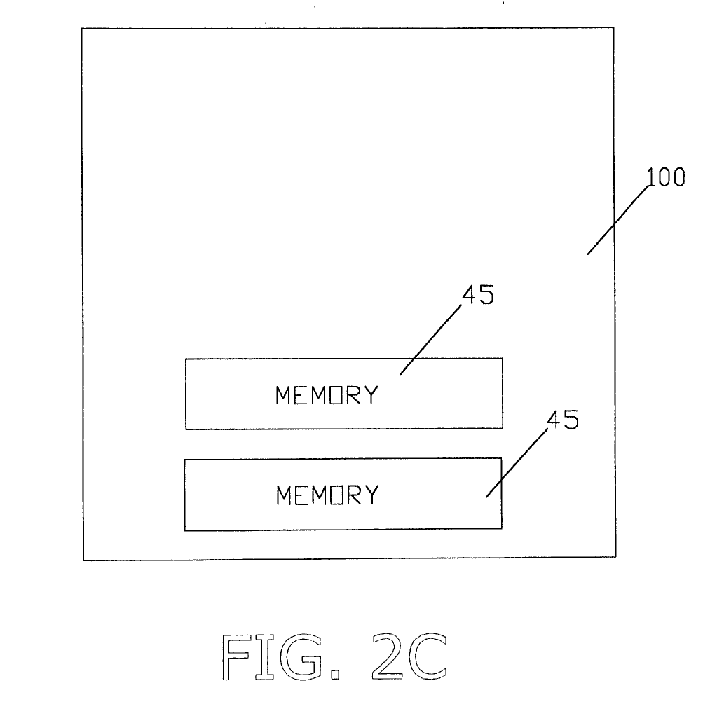

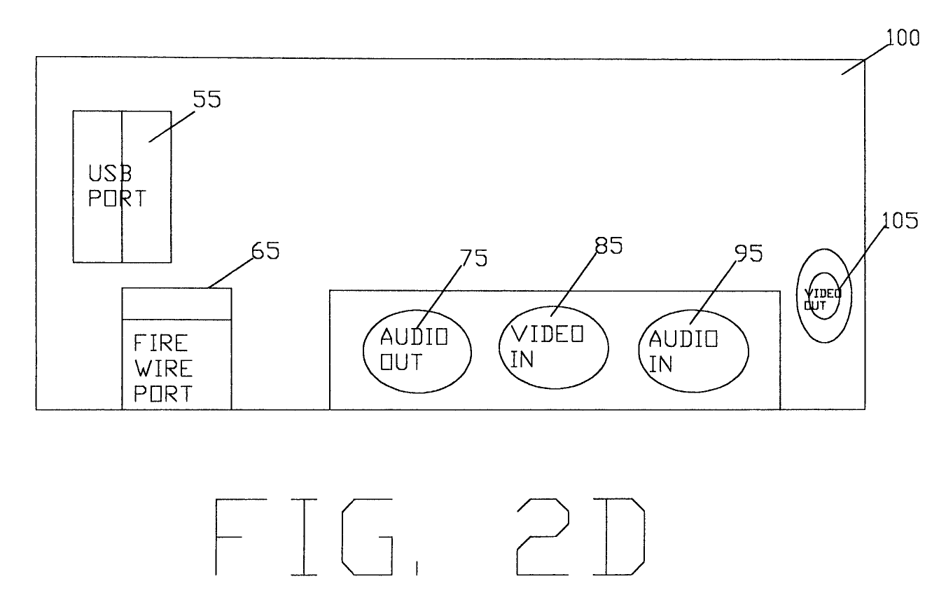

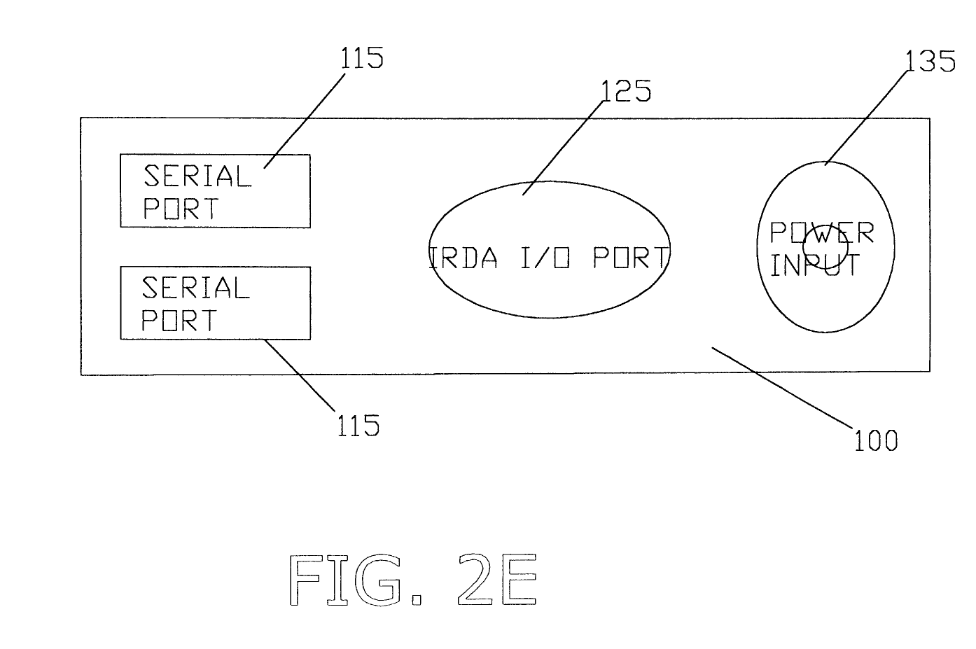

FIG. 2a is a schematic depiction of a top view of a client computer used in the vehicle computer system of FIG. 1;

FIG. 2b is a schematic depiction of a removable hard drive of the client computer of FIG. 2a;

FIG. 2c is a schematic depiction of a bottom view of the client computer of FIG. 2a;

FIG. 2d is a schematic depiction of a first side view of the client computer of FIG. 2a; and

FIG. 2e is a schematic depiction of a second opposing side view of the client computer of FIG. 2a.

### DETAILED DESCRIPTION OF THE INVENTION

FIG. 1 shows a vehicle computer system 1 according to the preferred embodiment of this invention. Vehicle computer system 1 comprises a client computer 100 including a processor 5, a fan 15 for controlling the temperature of the processor 5, and a removable internal hard drive 25, as shown in FIG. 2a. Those skilled in the art will appreciate that processor 5 may comprise a single processor or multiple processors that are connected together to carry out processes in tandem. The removable hard drive 25 includes two shock absorbent brackets 35, as shown in FIG. 2b, for removably attaching the hard drive 25 of client computer 100 to any location inside of the vehicle 2. The client computer 100 also includes an easy access memory 45, as shown in FIG. 2c, and input and output interfaces including an audio input 95 (such as a microphone not shown), an audio output 75, a video input 85, and a video output 105, as shown in FIG. 2d, a power input 135 and I/O IrDA (Infrared Developer's Association) port 125, as shown in FIG. 2e, all conventionally interconnected by a bus (not shown).

The client computer 100 includes other components such as Serial Port 115 (FIG. 2e), USB Port 55 and Fire Wire Port 65 (FIG. 2d) for providing universal communication between the vehicle computer system 1, peripheral devices 70 and vehicle components (not shown). The vehicle computer system 1 further comprises a communications link 110, which allows the client computer 100 to communicate with server 90, other processing units (not shown), data storage devices (not shown), or peripheral devices 70. Besides the aforementioned USB Port 55, Fire Wire Port 65, or Serial Port 115, communications link 110 may comprise USB Hub 40, Fire Wire Hub 50, RF link, or Audio Hub or any of the common buses or interfaces with configuration space, which are well known in the art, such as ISA, EISA, MCA, PCI, SCSI, PCMCIA, CardBus, etc (not shown).

As shown in FIG. 1, the vehicle computer system 1 also provides additional peripheral devices including at least four cameras 120 and at least eight infrared sensors 130 removably attached to the front, rear, and two sides of the vehicle 2. In operation, the infrared sensors 130 detect body heat near the area surrounding the vehicle 2 and transmit a signal to the client computer 100 to turn on the camera(s) 120. The camera(s) 120 will then record images of the intruder and transmit the images to the client computer 100, wherein the images will be stored on the hard drive 25 and sent as an e-mail message to the display screen 145 to be displayed.

Read-only memory devices within client computer 100 such as ROM memory, a CD-ROM drive, flash memory and battery-packed RAM (not shown) are provided for retrieving stored information stored on non-writable storage media, (e.g., CD-ROM disks) (not shown). For example, the CD ROM drive reads application-related CDs, as well as musical, video, game, or other types of entertainment CDs. The client computer 100 also receives information from various read and write peripheral devices 70 such as a floppy diskette drive, a hard disk drive, A DVD (digital video disk), CD-RW, DVD-RW (not shown) for storing alterable information from a writable storage media (e.g, floppy disks). The client computer 100 and peripheral devices 70 may receive information through a communications medium, such as server, another computer or telephone network, including wireless communications.

The client computer 100 runs an open platform operating system which supports multiple applications contained on the hard drive 25 and/or the CD-ROM drive of peripheral devices 70. Using the open platform operating system and an open computer system architecture, various software applications and hardware peripheral devices 70 produced by independent vendors may be subsequently installed by the vehicle 2 user after purchase of the vehicle 2 so that the software applications do not need to be specially configured for uniquely designed embedded systems. A preferred operating system is any Windows.RTM. brand operating system sold by Microsoft Corporation, such as Windows 95, 98, ME, 2000 pro, XP, CE.

In addition to having the infrared sensors 130, the client computer 100 of vehicle computer system 1 includes the IrDA transceiver port 125 to transmit and receive data and programs using infrared signals. The infrared sensors 130 includes one or more different kinds of hardware or apparatuses that sense the position of the vehicle 2 in its environment and features and conditions in the environment around the vehicle 2. Included among the infrared sensors 130 are apparatuses that detect stationary or moving objects physically in the vicinity around the vehicle. The infrared sensors 130 senses and detects other vehicles, pedestrians, buildings, lampposts, bridge abutments, lane barriers, fences, traffic signals, traffic signs, and so on. Upon detecting such obstacles, the infrared sensors 130 sends a signal to the processor 5 of client computer 100, which then sends data to server 90 that sends a signal to the brakes to automatically brake the vehicle 2 and thus prevent an accident. Various kinds of sensor devices may be used and the present embodiment is not restricted to any particular type of sensor or combination of sensors. Besides infrared sensors 130, examples of additional sensors devices that may be used to perform the desired functions include a radar system, a video camera CCD, a laser device, as well as other devices.

The client computer 100 also has a navigation application that includes program code for a global positioning system (GPS) receiver 155 and program code for mapping functionality (e.g., “Automap” from Microsoft Corporation). The GPS data receiver 155, included in client computer 100, receives signals from, for example, a satellite-based navigation system. Data from a GPS interface is transmitted to client computer 100, which performs calibration, signal processing, dead-reckoning, vehicle positioning, and route guidance functions. Updateable map information and the program code for the mapping functionality may be stored in hard drive 25.

The vehicle computer system 1 also comprises graphics controller software that receives data processed by the client computer 100 and transmits the data to an output communicator comprising a display screen 145 with associated audio electronics and audio speakers (not shown). The driver may input data, such as a desired destination, through a user interface such as a keyboard (not shown).

Additionally, the computer has voice recognition software to permit the user to verbally enter commands in a hands-free, eyes-free environment. Any known voice and text recognition system including Dragon System's Naturally Speaking software and AT&T's Watson Speech Recognition software may be used to convert speech to text and text to speech. Using audio input 95 included in client computer 100 the above software will convert the speech to text for purposes of creating documents, e-mails, and other text documents including GPS related documents. Such software can be used to format text by voice and even control certain aspects of the computer system. Moreover, such software also has a text recognition system that can be used for example to translate a received e-mail from text to voice and transmit the e-mail message including sender name to the user as an audio message. The e-mail recipient can then verbally dictate an e-mail message, which the software will translate into text to be transmitted as a reply to the original e-mail.

The client computer 100 is coupled to a vehicle battery 30, a backup battery 10, antenna(s) (not shown) and the various external peripheral devices 70. The client computer 100 is coupled to the many peripheral devices 70 by communication link 110. Example peripheral devices 70 include without limitation a television tuner, video display, stereo, digital camera, disk drive, tape drive, CD-ROM drive, a PCMCIA drive, a DVD player, an OBD (On Board Diagnostic) system, a security system, a navigation system, a monitor, a printer, speakers, infrared sensors, a wireless link to the Internet and user I/O devices such as a joystick, keyboard, mouse, disk drive, printer, modem, scanner, serial port, parallel port, etc.

In this way, client computer 100 can operate a variety of vehicle and traditional computer functions. For example, the client computer 100 provides internet access through an RF link, such as a cellular phone, or wireless modem (not shown). A television picture may be displayed on the display screen 145. The display screen 145 may also display the image from any of the front or rear mounted digital cameras 120, which may be used for collision avoidance, and blind spot images from additional cameras located on each side of the vehicle. Likewise, the car stereo system (not shown) may be operated through the client computer 100 to achieve additional functions, such as automated selection of desired programming. The same functions may be provided by the client computer 100 to the peripheral devices 70, such as CD changer and DVD player, also coupled to the client computer 100 via a communication link 110, such as USB Hub 40 and Fire Wire Hub 50, respectively.

The vehicle computer system 1 including the client computer 100, server 90, and peripheral devices 70 are powered by a power system which comprises the vehicle battery 30 and/or any conventional AC-power supply and/or backup battery 10. The vehicle battery 30 and/or backup battery 10 provide power to the client computer 100, server 90 and peripheral devices 70 via power cables 20. The power system ensures that the vehicle computer system 2 has power in the event that the primary vehicle battery 30 is disconnected, becomes discharged, or during engine starting. To alleviate potential problems, the power system comprises a backup battery 10, which functions as a secondary power source to the vehicle computer system 1. The backup battery 10 may be solar charged. The backup battery 10 provides sufficient power to support the vehicle computer system 1. The power system also includes a switch 42 which enables the primary vehicle battery 30 to be connected to the backup battery 10 as needed to ensure a continuous power to the vehicle computer system 1. The backup battery 10 supplies power to the vehicle battery 30 when such battery is low on power. In particular, when the vehicle battery 30 is low on power or the vehicle is off, the power inverter 80 broadcasts an audio signal to the user indicating that the user should then turn switch 42 on to connect the backup battery 10 to the vehicle battery 30. The user can then turn switch 42 off either when the car is restarted or the vehicle battery 30 has sufficient power to run the vehicle computer system 1. In operation, the power from the vehicle battery 30 is fed through power cable 20 to a power inverter 80, which converts the DC power to the appropriate levels of AC power for use in the client computer 100 and/or peripheral devices 70. The power inverter 80 supplies AC power to the client computer 100 and/or peripheral devices 70 via power cables 20.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

What is claimed is:

1. A vehicle computer system comprising:
a client computer;
a server connected to the client computer by one of a plurality of communication links;
a plurality of peripheral devices connected to the client computer by a second of the communication links;
a vehicle battery connected to the client computer by one of a plurality of power cables;
a backup battery being connected to the vehicle battery by a switch, wherein the switch is turned on when the vehicle battery is low on power; and
a power inverter for converting an direct current voltage from one of a vehicle battery and a backup battery into an alternating current, wherein the alternating current supplies power to the client computer and the plurality of peripheral devices.

2. The vehicle computer system of claim 1, further comprising a plurality of cameras attached to various locations around the periphery of a vehicle for transmitting images to the client computer.

3. The vehicle computer system of claim 2, further comprising a plurality of infrared sensors attached to various locations around the periphery of a vehicle and transmitting signals to an IrDa port within the client computer for client computer to turn the cameras on.

4. The vehicle computer system of claim 1, further comprising a plurality of infrared sensors attached to various locations around the periphery of a vehicle and transmitting signals to an IrDa port within the client computer for transmitting data to the server to apply the brakes of the vehicle.

5. The vehicle computer system of claim 1, wherein the client computer further comprises an internal hard drive including shock absorbent brackets for removably attaching the client computer to a location within a vehicle.

6. The vehicle computer system of claim 1, wherein the plurality of peripheral devices comprises a least one of a floppy diskette drive, a hard disk drive, A DVD (digital video disk), a CD-RW, a DVD-RW, a television tuner, a video display, a stereo, a digital camera, a tape drive, a PCMCIA drive, a CD-ROM drive, an OBD (On Board Diagnostic) system, a security system, a navigation system, a monitor, a printer, a plurality of speakers, a plurality of infrared sensors, a wireless link to the Internet, a joystick, a keyboard, a mouse, a printer, a modem, a scanner, a serial port and a parallel port.

7. The vehicle computer system of claim 1, wherein the plurality of communication links comprises at least one of a USB Port, a Fire Wire Port, a Serial Port, a USB Hub, a Fire Wire Hub, an Audio Hub, buses, interfaces including at least one of an ISA, an EISA, a MCA, a PCI, a SCSI, a PCMCIA, and a CardBus.

8. The vehicle computer system of claim 1, wherein the client computer further comprises a GPS data receiver for receiving signals from a satellite-based navigation system and performing calibration, signal processing, dead-reckoning, vehicle positioning, and route guidance functions.

9. The vehicle computer system of claim 1, wherein the client computer further comprises an audio input and voice and speech recognition software for converting speech to text and text to speech.
